(19) United States
(12) Patent Application Publication
(10) Pub. No.: US 2025/0071679 A1
(43) Pub. Date: Feb. 27, 2025

(54) METHOD, DEVICE AND COMPUTER READABLE MEDIUM FOR COMMUNICATIONS

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/847,947

(22) PCT Filed: Apr. 12, 2022
(86) PCT No.: PCT/CN2022/086441

§ 371 Date: Sep. 17, 2024

(51) Int. Cl. H04W 52/02; H04W 76/28

(52) U.S. Cl. CPC H04W 52/0216; H04W 76/28

(57) ABSTRACT

Embodiments of the present disclosure relate to methods, devices and computer readable media for communications. According to embodiments of the present disclosure, a terminal device receives a dormancy transmission configuration associated with a plurality of cells serving the terminal device from a network device. The dormancy transmission configuration comprising timing information which indicates at least one of a first duration for an inactive mode of at least one cell of the plurality of cells and a second duration for an active mode of the at least one cell. The terminal device receives a first indication which indicates a first periodicity for a transmission of a tracking reference signal or synchronization signal on the at least one cell during the active mode from the network device. A second periodicity for a transmission of the tracking reference signal or synchronization signal on the at least one cell during the inactive mode is larger than the first periodicity, or the transmission of the tracking reference signal or synchronization signal on the at least one cell during the inactive mode is disabled. The terminal device performs a data communication with the network device via the plurality of cells based on the dormancy transmission configuration.

### FIELD

Embodiments of the present disclosure generally relate to the field of communication, and in particular, to a method, device and computer readable medium for controlling transmissions at network devices.

### BACKGROUND

With the development of communication technology, for saving energy of devices in a communication system, Discontinuous Transmission (DTX) and Discontinuous Reception (DRX) have been introduced. For example, in a DRX procedure for a terminal device, the terminal device may stop performing data reception in a DRX-off duration, or perform data reception in a DRX-on duration. Further, in order to improve the communication efficiency, a terminal device may be served by a plurality of cells provided by a network device. With the carrier aggregation (CA) technology, the terminal device may perform data communication on a bandwidth part (BWP) of a component carrier of a plurality of component carriers, and each component carrier is associated with a corresponding cell of the plurality cells. However, existing DTX and DRX are mainly applied from the perspective of terminal devices, the energy saving scheme, such as DTX and DRX, for the network device are not considered in detail, especially for the CA scenario. In addition, if DTX and/or DRX is applied at the network device side, the matching between transmission/reception window of the terminal device and reception/transmission window of the network device is also a key aspect.

### SUMMARY

In general, example embodiments of the present disclosure relate to methods, devices and computer readable media for controlling transmission at network devices.

In a first aspect, there is provided a method implemented by a terminal device. In the method, the terminal device receives a dormancy transmission configuration associated with a plurality of cells serving the terminal device from a network device. The dormancy transmission configuration comprising timing information which indicates at least one of a first duration for an inactive mode of at least one cell of the plurality of cells and a second duration for an active mode of the at least one cell. The terminal device receives a first indication which indicates a first periodicity for a transmission of a tracking reference signal or synchronization signal on the at least one cell during the active mode from the network device. A second periodicity for a transmission of the tracking reference signal or synchronization signal on the at least one cell during the inactive mode is larger than the first periodicity, or the transmission of the tracking reference signal or synchronization signal on the at least one cell during the inactive mode is disabled. The terminal device performs a data communication with the network device via the plurality of cells based on the dormancy transmission configuration.

In a second aspect, there is provided a method implemented at a network device. In the method, the network device transmits a dormancy transmission configuration associated with a plurality of cells serving the terminal device to a terminal device. The dormancy transmission configuration comprises timing information which indicates at least one of a first duration for an inactive mode of at least one cell of the plurality of cells and a second duration for an active mode of the at least one cell. The network device transmits a first indication which indicates a first periodicity for a transmission of a tracking reference signal or synchronization signal on the at least one cell during the active mode to the terminal device. A second periodicity for a transmission of the tracking reference signal or synchronization signal on the at least one cell during the inactive mode is larger than the first periodicity, or the transmission of the tracking reference signal or synchronization signal on the at least one cell during the inactive mode is disabled. The network device performs a data communication with the network device via the plurality of cells based on the dormancy transmission configuration.

In a third aspect, there is provided a terminal device. The terminal device comprises a processor and a memory coupled to the processor and storing instructions thereon, the instructions, when executed by the processor, causing the terminal device to perform the method of the first aspect.

In an fourth aspect, there is provided a network device. The network device comprises a processor and a memory coupled to the processor and storing instructions thereon, the instructions, when executed by the processor, causing the network device to perform the method of the second aspect.

In a fifth aspect, there is provided a computer readable medium having instructions stored thereon, the instructions, when executed on at least one processor, causing the at least one processor to perform the method of any one of the first aspect to the second aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which some embodiments of the present disclosure can be implemented;

FIG. 2 illustrates a signaling process for configuring dormancy transmission configuration according to some embodiments of the present disclosure:

FIG. 3 illustrates a dormancy transmission configuration according to some embodiments of the present disclosure:

FIG. 4 illustrates a dormancy transmission configuration according to some embodiments of the present disclosure:

FIG. 5 illustrates a dormancy transmission configuration according to some embodiments of the present disclosure:

FIG. 6 illustrates a dormancy transmission configuration according to some embodiments of the present disclosure:

FIG. 7 illustrates a dormancy transmission configuration according to some embodiments of the present disclosure:

FIG. 8 illustrates a dormancy transmission configuration according to some embodiments of the present disclosure:

FIG. 9 illustrates a dormancy transmission configuration according to some embodiments of the present disclosure;

FIG. 10 illustrates a dormancy transmission configuration according to some embodiments of the present disclosure:

FIG. 11 illustrates a determination of valid reception duration according to some embodiments of the present disclosure:

FIG. 12 illustrates a determination of valid reception duration according to some embodiments of the present disclosure:

FIG. 13 illustrates a flowchart of an example method implemented at a terminal device in accordance with some embodiments of the present disclosure:

FIG. 14 illustrates a flowchart of an method implemented at a network device in accordance with some embodiments of the present disclosure; and

FIG. 15 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low; power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information. The terminal or the network device may work on several frequency ranges, e.g. FR1 (410 MHz-7125 MHZ), FR2 (24.25 GHz to 71 GHZ), 71 GHz to 114 GHZ, and frequency band larger than 100 GHZ as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organizing Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below:

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As mentioned above, energy saving scheme, such as DTX and DRX, are mainly applied at terminal device side. At network device side, one solution for energy saving is that the network device may de-active a cell, for example, a Secondary Cell (SCell), in the plurality cells provided by the network device. However, the associated synchronization signal and Physical Broadcast Channel (PBCH) are still transmitted normally on this de-activated cell, and therefore the energy saving efficiency of the network device is limited. Further, the terminal device may experience a considerable delay caused by activation procedure for this cell.

The example embodiments of the disclosure propose a mechanism for controlling transmissions at network devices. In this mechanism, the network device may configure a dormancy transmission configuration to a terminal device, and the dormancy transmission configuration indicates timing information associated with active mode and inactive mode of a cell to the terminal device. In the inactive mode, the physical downlink channel transmission is stopped, and a periodicity of transmissions of a tracking reference signal or synchronization signal on this cell is increased relative to the active mode, or even the transmission of the channel reference signal or synchronization signal on this cell is disabled. In the case that the transmission of the channel reference signal or synchronization signal is disabled, the terminal device receives the tracking reference signal and synchronization signal in another reference cell.

Specifically, a terminal device receives a dormancy transmission configuration associated with a plurality of cells serving the terminal device from a network device, the dormancy transmission configuration comprises timing information which indicates a first duration for an inactive mode of at least one of the plurality of cells and/or a second duration for an active mode of the at least one cell. The terminal device receives a first indication which indicates a first periodicity for a transmission of a tracking reference signal or synchronization signal on the at least one cell during the active mode from the network device. A second periodicity for a transmission of the tracking reference signal or synchronization signal on the at least one cell during the inactive mode is larger than the first periodicity, or the transmission of the tracking reference signal or synchronization signal on the at least one cell during the inactive mode is disabled. The terminal device further performs a data communication with the network device via the plurality of cells based on the dormancy transmission configuration.

In this way; the energy saving efficiency of network device may be further improved (for example, a cell may get into deep sleeping/inactive mode/dormancy state). In addition, the traffic continuity and Radio Resource Control (RRC) connection of the terminal device can be maintained, since the terminal device may anchor in a reference cell in the plurality of cells which may transmit the tracking signal or synchronization signal for the at least one cell.

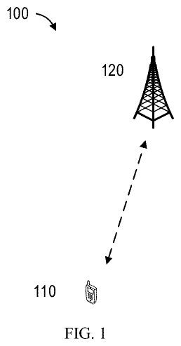

FIG. 1 illustrates an example environment 100 in which example embodiments of the present disclosure can be implemented.

The environment 100, which may be a part of a communication network, comprises a terminal device 110 and a network device 120. The terminal device 110 may be served by a plurality of cells provided by the network device 120. With the CA technology, the terminal device 110 may perform data communication with the network device 120 on a BWP of a component carrier of a plurality of component carriers which each is associated with a corresponding cell of the plurality cells.

It is to be understood that the number of terminal devices and network device is shown in the environment 100 only for the purpose of illustration, without suggesting any limitation to the scope of the present disclosure. In some embodiments, the environment 100 may comprise a further terminal device to communicate information with a further network device.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

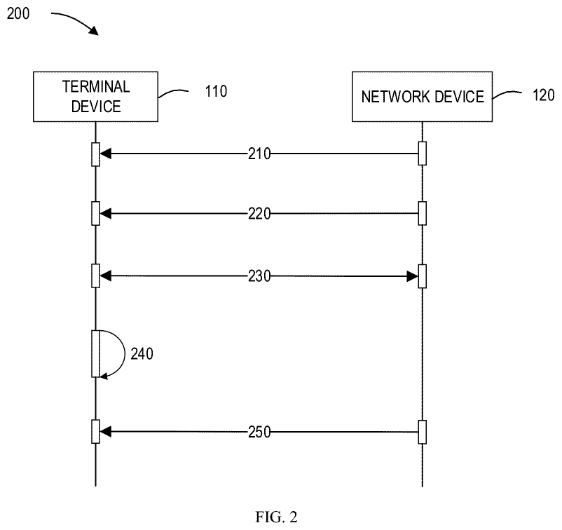

FIG. 2 illustrates a signaling process 200 for configuring dormancy transmission configuration according to some embodiments of the present disclosure. For purpose of discussion, the process 200 will be described with reference to FIG. 1.

In the signaling process 200, the terminal device 110 receives (210) a dormancy transmission configuration associated with a plurality of cells serving the terminal device from the network device 120. The dormancy transmission configuration comprises timing information which indicates at least one of a first duration for an inactive mode of at least one of the plurality of cells and a second duration for an active mode of the at least one cell.

In this disclosure, “the inactive mode of a cell” and “a TX off-duration for a cell” have the similar meanings and may be used interchangeably. The “active mode for a cell” and “a TX on-duration for a cell” have the similar meanings and may be used interchangeably. In addition, the ending of the inactive mode of the at least one cell also means that the starting of the active mode of the at least one cell, and the ending of the active mode also means that the starting of the inactive mode.

In some embodiments, the at least one cell may comprise one or more SCells. During the inactive mode (or during the first duration), the one or more SCells may perform no transmission of physical downlink channel (for example, Physical Downlink Control Channel, PDCCH, Physical Downlink Shared Channel, PDSCH and Channel State Information Reference Signal, CSI-RS), and perform transmission of channel reference signal (for example, Tracking Reference Signal, TRS) and synchronization signal (for example, Primary Synchronization Signal, PSS, Secondary Synchronization Signal, SSS, or synchronization signal/PBCH block, SSB) in a periodicity larger than that in the active mode. In some embodiments, the TRS may comprise a set of CSI-RS resource which is used for synchronization of the frequency domain and time domain. In addition or alternatively, the SCell may even perform no transmission of the channel reference signal and synchronization signal during the inactive mode. In some embodiments, the at least one cell may comprise further cells in the plurality of cells, for example, Primary Cell (PCell) or Special Cell (SpCell).

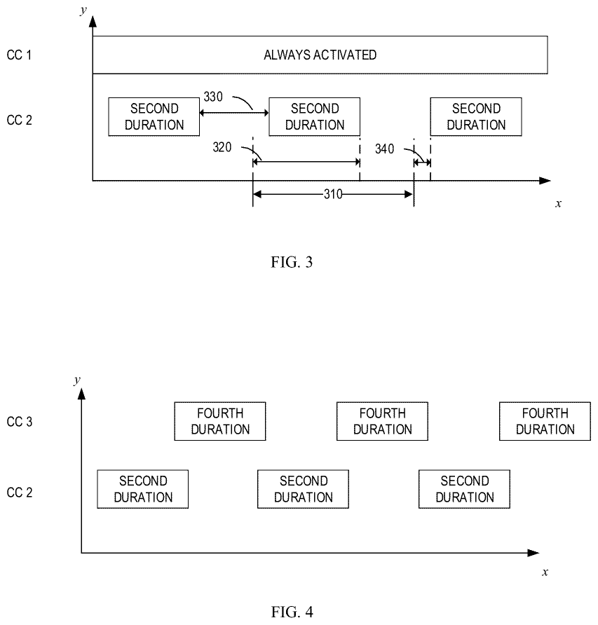

In some embodiments, the timing information may comprise: periodicity, starting point and a timer or a length for the first duration or the second duration. For discussion clarity, this dormancy transmission configuration is discussed with reference to FIG. 3. In some embodiments, the terminal device 110 may receive this dormancy transmission configuration in a Radio Resource Control (RRC) signaling.

FIG. 3 illustrates a dormancy transmission configuration according to some embodiments of the present disclosure.

As shown in the FIG. 3, x axis represents time domain, y axis represents frequency domain, and only for illustrating, CC 1 is a component carrier associated with another cell other than the at least one cell, CC 2 is a component carrier associated with the at least one cell. In an example, the timing information in the dormancy transmission configuration may indicate a third periodicity 310 for the active mode of the at least one cell, a timing offset 320 for the active mode and a timer for the active mode. With this timing information, the terminal device 110 may determine the third periodicity 310 of the second duration and a starting point/time/location of the second duration. The terminal device 110 may further determine a length 330 of the first duration based on the timer for the active mode. In this way; the terminal device 110 may determine each of the first durations for the at least one cell. As mentioned above, the ending of the inactive mode of the at least one cell also means that the starting of the active mode of the at least one cell, and the ending of the active mode also means that the starting of the inactive mode, the terminal device may determine the second duration in each periodicity accordingly.

In addition or alternatively, the timing information in the dormancy transmission configuration may also indicate the third periodicity 310 for the inactive mode, a timing offset 340 for the inactive mode and a timer for the inactive mode. With the timing information, the terminal device 110 may determine a third periodicity 310 of the second duration and a starting point/time/location of the second duration. The terminal device 110 may further determine a length of the second duration based on the timer for the inactive mode. Similarly, the terminal device may further determine the first duration in each periodicity accordingly.

In addition, in some embodiments, the timing information may further indicate at least one of a third duration for an inactive mode of a cell in the plurality of cells other than the at least one cell and a fourth duration for an active mode of the cell. The first duration and the third duration at least partially do not overlap, or the second duration and the fourth duration at least partially do not overlap. For discussion clarity, the timing information further indicating the third and fourth duration is discussed with reference to FIG. 4.

FIG. 4 illustrates a dormancy transmission configuration according to some embodiments of the present disclosure.

As shown in FIG. 4, CC 3 is a component carrier associated with a cell in the plurality of cells other than the at least one cell. In some embodiments, the first duration and the third duration at least partially do not overlap, or the second duration and the fourth duration at least partially do not overlap. In this way, the active mode for the at least one cell and the active mode for the cell other than the at least one cell are configured to be “staggered” in time domain. In this way, the terminal device may be served by at least one cell of the plurality of cells, even though the dormancy transmission has been applied on the plurality of cells. In some embodiments, the first duration and the third duration do not overlap, or the second duration and the fourth duration do not overlap.

In some embodiments, the plurality of cell may be divided into a first group of cells and a second group of cells. The timing information indicating the first duration and second duration is configured to the first group and the timing information indicating the third duration and second duration is configured to the second group. Then the cells in the first group may perform transmissions based on the first duration and second duration, the cells in the second group may perform transmissions based on the third duration and fourth duration.

Referring back to FIG. 2, in addition or alternatively to the timing information indicating periodicity, the dormancy transmission configuration may comprise at least one of an inactive indication and an active indication. The active indication and inactive indication may indicate the start point of associated first duration and second duration. For discussion clarity, the dormancy transmission configuration comprising the at least one of the inactive indication and the active indication is discussed with reference to FIG. 5.

FIG. 5 illustrates a dormancy transmission configuration according to some embodiments of the present disclosure.

In some embodiments, the terminal device 110 may be configured with a specific search space for the active indication or inactive indication. For example, the search space may comprise a set of resources and at least one detection occasion for the active indication or inactive indication. The terminal device 110 may detect the active indication or inactive indication in this search space accordingly. For example, the active indication or inactive indication may comprise a field in a Downlink Control Information (DCI) transmitted from the network device 120. In some embodiments, the active indication or inactive indication may comprise a predefined sequence.

In some embodiments, the active indication may indicate to start the first duration after a first gap, and the active indication may indicate to start the second duration after a second gap. If detecting the inactive indication 501 in the specific search space, the terminal device 110 may assume that the at least one cell will transition into the inactive mode after the second gap 510, and the inactive mode lasts the second duration. In turn, if detecting the active indication 520 in the search space, the terminal device 110 may assume that the at least one cell will transition into the active mode after the first gap 530 and the active mode lasts the first duration.

In some embodiments, the search space may be configured on a component carrier (CC1 as shown in FIG. 5) associated with another cell other than the at least one cell. For example, the search space may be configured on a component carrier associated with a reference cell. The reference cell may comprise at least one of: PCell, PSCell or a serving cell indicated by the network device 120.

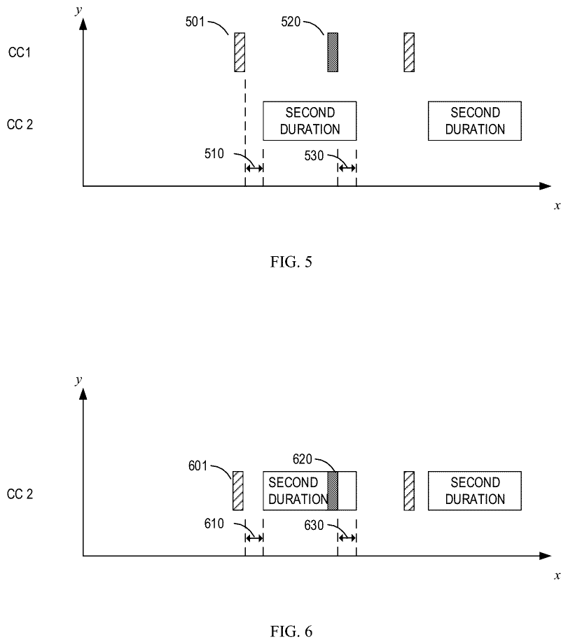

In addition or alternatively, the search space may be configured on the component carrier (CC2) associated with the at least one cell. For discussion clarity, the search space configured on the component carrier associated with the at least one cell is discussed with reference to FIG. 6.

FIG. 6 illustrates a dormancy transmission configuration according to some embodiments of the present disclosure.

As shown in FIG. 6, the search space is configured on the component carrier (CC2) associated with the at least one cell. If detecting the inactive indication 601 in the search space, the terminal device 110 may assume that the at least one cell will transition into the inactive mode after the second gap 610, and the inactive mode lasts the second duration. In turn, if detecting the active indication 620 in the search space, the terminal device 110 may assume that the at least one cell will transition into the active mode after the first gap 630 and the active mode lasts the first duration.

In some embodiments, the timing information further indicating the third periodicity and the active indication or inactive indication may be employed in combination. For example, if detecting the inactive indication, the terminal device 110 may assume that the at least one cell will transition into the inactive mode after the second gap 610, and the inactive mode lasts the second duration. In addition, the terminal device 110 may assume that the subsequent inactive mode and active mode are occurred with the periodicity indicated by the timing information if there is no further active or inactive indication.

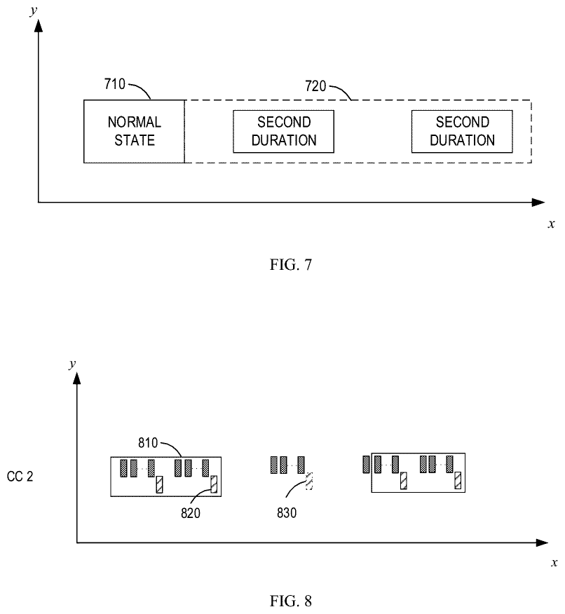

Referring back to FIG. 2, the terminal device 110 may be also configured with a specific dormancy state. If the terminal device 110 has been configured with the dormancy state, the terminal device 110 consider, only in the dormancy state for the terminal device 110, the active mode and inactive mode of the at least one cell. For discussion clarity, the dormancy state for the terminal device is discussed with reference to FIG. 7.

FIG. 7 illustrates a dormancy transmission configuration according to some embodiments of the present disclosure.

As shown in FIG. 7, the terminal device 110 may have two states: a normal state 710 and a dormancy state 720. In the normal state 710, the terminal device 110 may assume that the network device 120 transmits physical downlink channel, the tracking reference signal or synchronization signal always, and the terminal device 110 may perform the reception without considering any inactive mode for the at least one cell. In turn, in the dormancy state 710, the terminal device 110 may perform the reception of the physical downlink channel, the tracking reference signal or synchronization signal based on the received dormancy transmission configuration accordingly.

In some embodiments, the terminal device 110 may receive a dormancy state indication for the terminal device, and the dormancy state indication indicates a dormancy state duration for the terminal device. Then, the terminal device 110 may perform (230), during the inactive mode and on the at least one cell, a reception of the tracking reference signal or synchronization signal with the second periodicity and performing no reception of the physical downlink channel.

Referring back to FIG. 2, the terminal device 110 receives (220) a first indication which indicates a first periodicity for a transmission of a tracking reference signal or synchronization signal on the at least one cell during the active mode. A second period for a transmission of the tracking reference signal or synchronization signal on the at least one cell during the inactive mode is larger than the first periodicity, or the transmission of the tracking reference signal or synchronization signal on the at least one cell during the inactive mode is disabled.

It is to be understood that the steps 210 and 220 are ordered in FIG. 2 only for discussion purpose, and the step 220 may also be performed before the step 210 or may also be performed in parallel with the step 220.

In some embodiments, the relation of the second periodicity and first periodicity is predefined. For example, the second periodicity may be predefined as N times of the first periodicity or the second periodicity may be predefined as equal to the first periodicity plus a fixed period. As such, upon the terminal device 110 receives the first indication indicating the first periodicity, the terminal device 110 may determine the second periodicity for the transmission of the tracking reference signal or synchronization signal during the inactive based on the above predefined relation.

In some embodiments, the second periodicity may be indicated by the network device 120 dynamically. For example, from the network device 120, the terminal device 110 may receive a scaling parameter N for the reception of the tracking reference signal or synchronization signal on the at least one cell during the inactive mode. The terminal device 110 may understand than the second periodicity is N times of the indicated first periodicity. Then, the terminal device 110 may perform (230) a data communication with the network device 120 via the plurality of cells based on the dormancy transmission configuration accordingly. For discussion clarity, the data communication based on the dormancy transmission configuration is discussed with reference to FIGS. 8-10.

FIG. 8 illustrates a dormancy transmission configuration according to some embodiments of the present disclosure.

As shown in FIG. 8, block 810 represents the second duration of the active mode for the at least one cell. During the active mode for the at least one cell, the terminal device 110 may receive the physical downlink channel and tracking reference signal or synchronization signal on the at least one cell with the first periodicity. For example, the terminal device 110 may perform the transmissions and receptions normally, such as performing the measurement, synchronization, Channel State Information (CSI) measurement, PDCCH monitoring, Physical Uplink Control Channel (PUCCH) transmission.

During the inactive mode for the at least one cell, the terminal device 110 may receive the tracking reference signal or synchronization signal (which is shown as the block with shadow above the block 820 in the FIG. 8) on the at least one cell with the second periodicity which is larger than the first periodicity: The second periodicity may be determined as discussed above. In some embodiments, the tracking reference signal or synchronization signal is also simplified during the inactive mode. For example, PBCH is transmitted as a part of the SSB during the active mode, however the PBCH is not transmitted during the inactive mode.

In addition, the terminal device 110 may perform no reception of the physical downlink channel during the inactive mode. At network device 120 sides, the network device 120 perform no transmission of the physical downlink channel 830 during the inactive mode indeed. In turn, the terminal device 110 may assume that the network device 120 performs no transmission of the physical downlink channel and perform no reception.

In addition or alternatively, the network device 120 may even perform no transmission of the physical downlink channel and the physical downlink channel and tracking reference signal during the inactive mode.

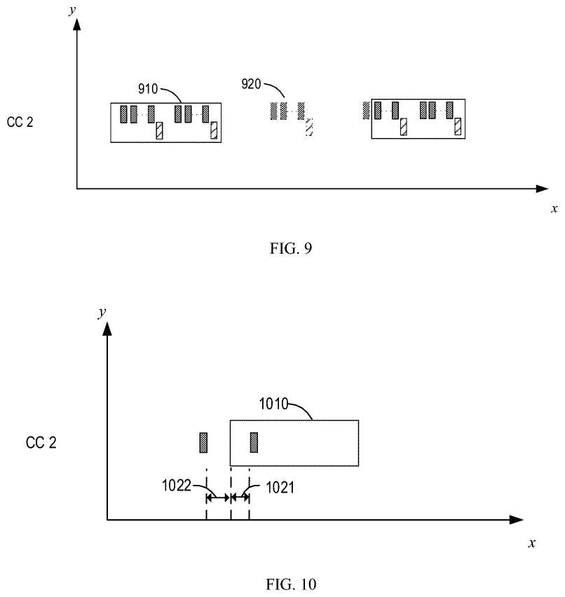

FIG. 9 illustrates a dormancy transmission configuration according to some embodiments of the present disclosure.

As shown in FIG. 9, block 910 represents the second duration of the active mode for the at least one cell. During the active mode for the at least one cell, the terminal device 110 may receive the physical downlink channel and tracking reference signal or synchronization signal on the at least one cell with the first periodicity. For example, the terminal device 110 may perform the transmissions and receptions normally, such as performing the measurement, synchronization, Channel State Information (CSI) measurement, PDCCH monitoring, Physical Uplink Control Channel (PUCCH) transmission.

During the inactive mode for the at least one cell, the terminal device 110 may perform no reception of the physical downlink channel and the tracking reference signal or synchronization signal, which are collectively represented as reference number 920 in the FIG. 8, on the at least one cell. At the network device 120 sides, the network device 120 may perform no transmission of the physical downlink channel and tracking reference signal or synchronization signal during the inactive mode.

In this case, the terminal device 110 may receive the tracking reference signal or synchronization signal for the at least one cell on another cell. In some embodiments, the other cell may comprise at least one of: a predefined reference cell, a PCell, PSCell and a cell indicated by the network device 120.

In this way, the at least one cell may transition into a “deep” inactive mode or sleep mode, and the energy saving efficiency can be optimized accordingly. Further, the traffic continuity of the terminal device 110 may be maintained as the terminal device may anchor on another reference cell.

In some embodiments, in order to ensure time and frequency synchronization of the terminal device 110 with the at least one cell in the active mode, an aperiodic tracking reference signal may be configured at the beginning of the second duration. For discussion clarity, this is discussed with reference to FIG. 10.

FIG. 10 illustrates a dormancy transmission configuration according to some embodiments of the present disclosure.

In some embodiments, the network device 120 may indicate an offset value for the aperiodic tracking reference signal relative to the starting time of the second duration. In some embodiments, this offset value may be the number of OFDM symbols or slots. In some embodiments, the aperiodic tracking reference signal may be comprised in the second duration. For example, the network device 120 may indicate a positive offset value indicating the length 1021. In addition or alternatively, the aperiodic tracking reference signal may be located before the second duration. For example, the network device 120 may indicate a negative offset value indicating the length 1022.

With the above steps, the terminal device 110 may perform data communication with the network device 120 considering the dormancy transmission configuration. Specifically, from the perspective of the terminal device 110, the terminal device 110 is configured with a DTX configuration (or dormancy transmission configuration) for a serving cell. In a DTX-off duration of the DTX configuration, the terminal device 110 may determine the serving cell is in a dormant state, for example, determine the BandWidth part (BWP) associated with the serving cell is in dormant. In addition, a dormant BWP may be activated in the DTX off-duration, wherein the dormant BWP is preconfigured by the network device 120. The terminal device 110 may perform measurement/synchronization/AGC in the dormant BWP, and do not monitor PDCCH.

In the DTX on-duration, in some embodiments, active BWP is preconfigured by the network device 120 to be used at the beginning of the DTX on-duration. In some embodiments, the active BWP is the most recent BWP used by the terminal device 110 in the previous DTX on-duration. In another embodiment, the active BWP is the most recent BWP other than the dormant BWP.

In addition or alternatively, the terminal device 110 may be also configured with DCI based dormant cell indication. In this case, if the terminal device 110 receives a DCI and the DCI indicates to switch into or switch out of the inactive mode for a serving cell, the terminal device 110 should follow this indication. If the terminal device 110 does receive a DCI indicate the inactive mode, the terminal device 110 should follow the above mentioned periodic cell active/inactive mechanism. For example, if the terminal device 110 receives a DCI (e.g., in the PCell) in a DTX off-duration, and the DCI indicates the serving cell is to be dormant state, then the terminal device 110 should keep considering the serving cell as in inactive mode in the next DTX on-duration, until it receives another DCI to indicate the terminal device 110 the serving cell should be in active mode.

As mentioned above, the terminal device 110 performs the data communication with the network device 120 via the plurality of cells based on the dormancy transmission configuration.

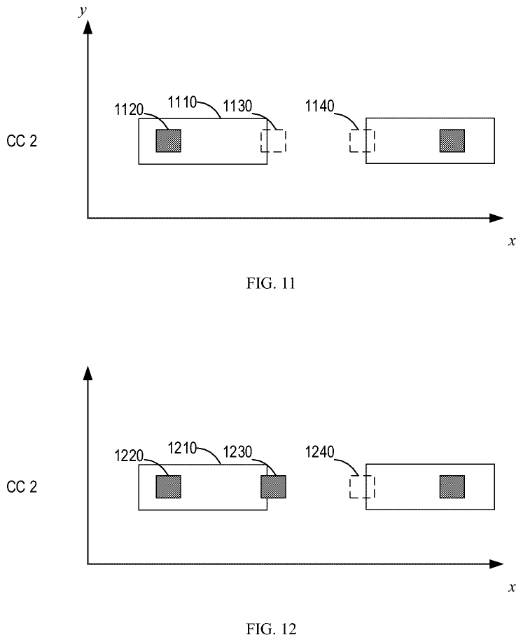

In addition, in some embodiments, the terminal device 110 may be also preconfigured with a discontinuous reception configuration. In this case, the terminal device 110 performs the data reception only in some predefined reception duration. In this case, the terminal device 110 should determine (240) valid reception duration matching the active mode for the at least one cell to perform (250) the data reception. Alternatively, the terminal device 110 may detect (240) a wake up signal on a search period matching with the second duration and determine whether to perform (250) the data reception based on the wake up signal. For discussion clarity; these are discussed with reference to FIGS. 11-12.

FIG. 11 illustrates a determination of valid reception duration according to some embodiments of the present disclosure.

As shown in FIG. 11, the block 1110 represents a second duration for the inactive mode of the at least one cell, the blocks 1120, 1130 and 1140 represent reception durations in the discontinuous reception configuration.

In some embodiments, based on a reception duration of the discontinuous reception configuration preconfigured for the terminal device 110 and the second duration, the terminal device 110 may determine a valid reception duration for the at least one cell. Then, the terminal device 110 performs the data reception from the at least one cell during the valid reception duration.

In some embodiments, the terminal device 110 may consider reception duration completely comprised in the second duration as the valid reception duration. For example, if the second duration 1110 comprises the reception duration 1120 completely, the terminal device 110 may determine the reception duration 1120 as the valid reception duration.

In turn, if the reception duration is not comprised in the second duration completely, for example, the reception durations 1130 and 1140, the terminal device may not determine these reception durations as the valid reception duration.

After the determination of the valid reception duration, the terminal device 110 wakes up to perform the data reception only during the determined valid reception duration.

In addition or alternatively, the terminal device may also determine a reception duration of which the initial portion is comprised in the second duration as the valid reception duration.

FIG. 12 illustrates a determination of valid reception duration according to some embodiments of the present disclosure.

As shown in FIG. 12, the block 1210 represents a second duration for the inactive mode of the at least one cell, the blocks 1220, 1230 and 1240 represent reception durations in the discontinuous reception configuration.

In some embodiments, if a first number of symbols of an initial portion of the reception duration comprised in the second duration is above a first threshold, the terminal device 110 may determine the reception duration as the valid reception duration. In some embodiments, the first threshold may be one OFDM symbol or a specific number of OFDM symbols. Alternatively, the first threshold is zero, in this case, if only the first one symbol of the reception duration is comprised the second duration, the reception duration may be also determined as the valid reception duration.

For example, the terminal device 110 may determine the blocks 1220 and 1230 as the valid reception duration. The block 1240 may be not determined as the valid reception duration, since the initial portion of the block 1240 is not comprised in the second duration.

In addition or alternatively, the terminal device 110 may detect a wake up signal on a preconfigured searching period and monitor the wake up signal to determine whether to perform the data reception during a reception duration associated with the wake up signal. In some embodiments, the reception duration associated with the wake up signal may be reception duration following the wake up signal. In some embodiments, the reception duration associated with the wake up signal may be indicated by the wake up signal. In some embodiments, the reception duration associated with the wake up signal may be one or more reception durations following the wake up signal.

In some embodiments, the wake up signal comprises two predefined sequences, a first sequence and a second sequence. In an example, if the terminal device 110 detects the first sequence on the preconfigured searching period, the terminal device 110 may wake up to perform the data reception during the associated reception duration. In turn, if the terminal device 110 detects the second sequence on the preconfigured searching period, the terminal device 110 may not wake up to perform the data reception during the associated reception duration.

In some embodiments, the terminal device 110 may detect the wake up signal only on a valid searching period among the preconfigured searching periods. In this case, the terminal device 110 may determine a valid searching period for a wake up signal based on a preconfigured searching period for the wake up signal and the second duration in advance.

In some embodiments, the terminal device may determine the valid searching period in the same way as determining the valid reception duration discussed in FIGS. 11-12. For example, in some embodiments, if a preconfigured searching period is comprised in the second duration completely, then the preconfigured searching period is determined as valid searching period.

In addition or alternatively, if a second number of symbols of an initial portion of a preconfigured searching period comprised in the second duration is above a second threshold, the terminal device 110 may determine preconfigured searching period as the valid reception duration.

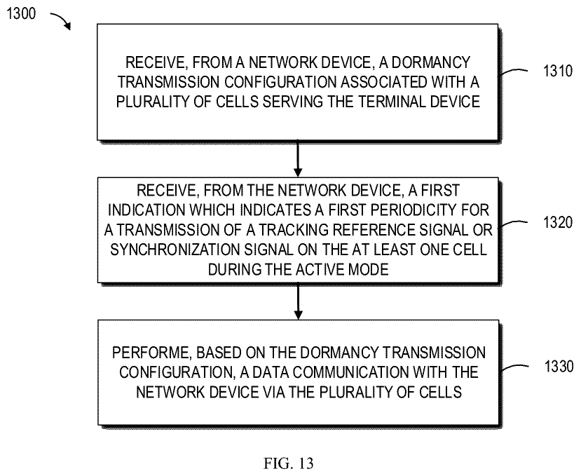

FIG. 13 illustrates a flowchart of a method 900 of communication implemented at a fourth network device in accordance with some embodiments of the present disclosure. The method 1300 can be implemented at the terminal device 110 shown in FIG. 1. For the purpose of discussion, the method 1300 will be described with reference to FIG. 1. It is to be understood that the method 1300 may include additional acts not shown and/or may omit some shown acts, and the scope of the present disclosure is not limited in this regard.

At block 1310, the terminal device 110 receives, from a network device 120, a dormancy transmission configuration associated with a plurality of cells serving the terminal device. The dormancy transmission configuration comprises timing information which indicates at least one of a first duration for an inactive mode of at least one cell of the plurality of cells and a second duration for an active mode of the at least one cell.

At block 1320, the terminal device 110 receives, from the network device 120, a first indication which indicates a first periodicity for a transmission of a tracking reference signal or synchronization signal on the at least one cell during the active mode. A second periodicity for a transmission of the tracking reference signal or synchronization signal on the at least one cell during the inactive mode is larger than the first periodicity, or the transmission of the tracking reference signal or synchronization signal on the at least one cell during the inactive mode is disabled.

At block 1330, the terminal device 110 performs, based on the dormancy transmission configuration, a data communication with the network device 120 via the plurality of cells.

In some embodiments, the timing information comprises: a third periodicity for the inactive mode or the active mode: a timing offset for the inactive mode or the active mode: and a timer for the inactive mode or the active mode.

In some embodiments, the dormancy transmission configuration comprises at least one of an inactive indication and an active indication, the inactive indication indicating to start the first duration after a first gap and the active indication indicating to start the second duration after a second gap.

In some embodiments, receiving the dormancy transmission configuration comprises: detecting the at least one of the inactive indication and the active indication in a specific search space, the specific search space being configured on a first component carrier associated with the at least one cell or being configured on a second component carrier associated with another cell in the plurality of cells.

In some embodiments, the other cell in the plurality of cells is indicated to the terminal device by the network device or the other cell is a predefined reference cell in the plurality of the cells.

In some embodiments, the timing information further indicates at least one of a third duration for an inactive mode of a cell in the plurality of the cells other than the at least one cell and a fourth duration for an active mode of the cell, and wherein the first duration and the third duration at least partially do not overlap, or the second duration and the fourth duration at least partially do not overlap.

In some embodiments, the method further comprising: receiving a dormancy state indication for the terminal device, the dormancy state indication indicating a dormancy state duration for the terminal device; and performing, during the dormancy state duration, the data communication with the plurality of cells based on the dormancy transmission configuration.

In some embodiments, performing the data communication comprises: performing, during the active mode and on the at least one cell, a reception of a physical downlink channel and one of the tracking reference signal or synchronization signal with the first periodicity; and performing, during the inactive mode and on the at least one cell, a reception of the one of the tracking reference signal or synchronization signal with the second periodicity and performing no reception of the physical downlink channel.

In some embodiments, the method further comprising: receiving, from the network device, a scaling parameter N for the reception of the tracking reference signal or synchronization signal on the at least one cell during the inactive mode; and performing, during the inactive mode and on the at least one cell, a reception of the tracking reference signal or synchronization signal with the second periodicity, the second periodicity is N times of the first periodicity.

In some embodiments, performing the data communication comprises: performing, during the active mode and on the at least one cell, a reception of a physical downlink channel and one of the tracking reference signal or synchronization signal with the first periodicity; and performing, during the inactive mode and on the at least one cell, no reception of the physical downlink channel and the one of the tracking reference signal or synchronization signal.

In some embodiments, performing the data communication comprising: performing, during the first duration and on another cell in the plurality of cells other than the at least one cell, a reception of the one of the tracking reference signal or synchronization signal for the at least one cell.

In some embodiments, the terminal device is preconfigured with discontinuous reception configuration, and the performing the data communication comprises: determining a valid reception duration for the at least one cell based on a reception duration of the discontinuous reception configuration and the second duration; and performing a data reception during the valid reception duration.

In some embodiments, determining the valid reception duration comprises: in accordance with a determination that the reception duration is comprised in the second duration, determining the reception duration as the valid reception duration.

In some embodiments, determining the valid reception duration comprises: in accordance with a determination that a first number of symbols of an initial portion of the reception duration being comprised in the second duration is above a first threshold, determining the reception duration as the valid reception duration.

In some embodiments, the terminal device is preconfigured with discontinuous reception configuration, and wherein performing the data communication comprises: determining a valid searching period for a wake up signal based on a preconfigured searching period for the wake up signal and the second duration; and monitoring the wake up signal in the valid searching period: monitoring the wake up signal in the valid searching period; and in accordance with a wake up signal is detected in the valid searching period, determining, based on the wake up signal, whether to perform a data reception during a reception duration associated with the wake up signal, the reception duration being indicated in the discontinuous reception configuration.

In some embodiments, determining the valid searching period comprises: in accordance with a determination that the preconfigured searching period is comprised in the second duration, determining the preconfigured searching period as the valid searching period.

In some embodiments, determining the valid searching period comprises: in accordance with a determination that a second number of symbols of an initial portion of the preconfigured searching period being comprised in the second duration is above a second threshold, determining the preconfigured searching period as the valid searching period.

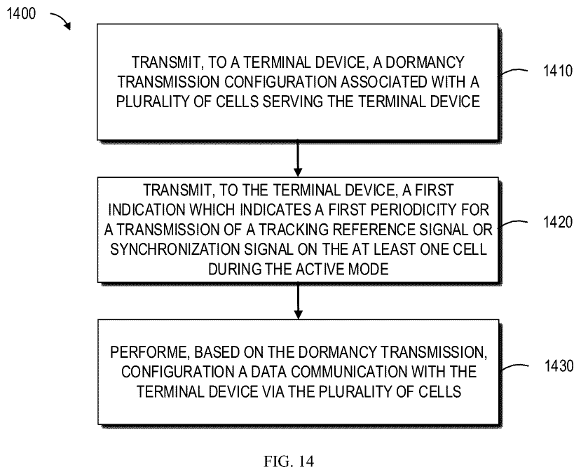

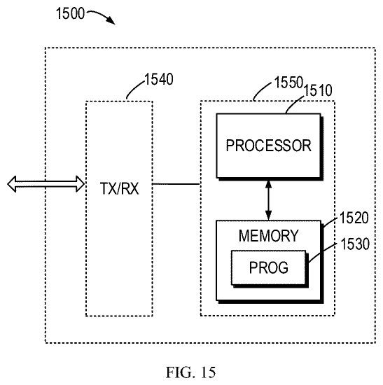

FIG. 14 illustrates a flowchart of a method 1400 of communication implemented at a network device in accordance with some embodiments of the present disclosure. The method 1400 can be implemented at the network device 120 shown in FIG. 1. For the purpose of discussion, the method 1400 will be described with reference to FIG. 1. It is to be understood that the method 1400 may include additional acts not shown and/or may omit some shown acts, and the scope of the present disclosure is not limited in this regard.

At block 1410, the network device 120 transmits, to a terminal device 110, a dormancy transmission configuration associated with a plurality of cells serving the terminal device.

At block 1410, the network device 120 transmits, to the terminal device 110, a first indication which indicates a first periodicity for a transmission of a tracking reference signal or synchronization signal on the at least one cell during the active mode.

At block 1420, the network device 120 performs, based on the dormancy transmission, configuration a data communication with the terminal device 110 via the plurality of cells.

In some embodiments, the timing information comprises: a third periodicity for the inactive mode or the active mode: a timing offset for the inactive mode or the active mode; and a timer for the inactive mode or the active mode.

In some embodiments, the dormancy transmission configuration comprises at least one of an inactive indication and an active indication, the inactive indication indicating a first gap before a starting occasion of the first duration and the active indication indicating a second gap before a starting occasion of the second duration.

In some embodiments, transmitting the dormancy transmission configuration comprises: transmitting the at least one of the inactive indication and the active indication in a specific search space, the specific search space being configured on a first component carrier associated with the at least one cell or being configured on a second component carrier associated with another cell in the plurality of cells.

In some embodiments, the other cell in the plurality of cells is indicated to the terminal device by the network device or the other cell is a predefined reference cell in the plurality of the cells.

In some embodiments, the timing information further indicates at least one of a third duration for an inactive mode of a cell in the plurality of the cells other than the at least one cell and a fourth duration for an active mode of the cell, and wherein the first duration and the third duration at least partially do not overlap, or the second duration and the fourth duration at least partially do not overlap.

In some embodiments, the method further comprising: transmitting a dormancy state indication for the terminal device, the dormancy state indication indicating a dormancy state duration for the terminal device.

In some embodiments, performing the data communication comprises: performing, during the active mode and on the at least one cell, a transmission of a physical downlink channel and one of the tracking reference signal or synchronization signal with a second periodicity; and performing, during the inactive mode and on the at least one cell, a transmission of the tracking reference signal and synchronization signal with the first and performing no transmission of the physical downlink channel.

In some embodiments, the method further comprising: transmitting, to the terminal device, a scaling parameter N for the reception of the one of the tracking reference signal or synchronization signal during the inactive mode; and performing, during the first duration and on the at least one cell, a transmission of the tracking reference signal and synchronization signal with the second periodicity, the second periodicity is N times larger than the second periodicity.

In some embodiments, performing the data communication comprises: performing, during the second duration and on the at least one cell, a transmission of a physical downlink channel and one of the tracking reference signal or synchronization signal with the first periodicity; and performing, during the inactive mode and on the at least one cell, no transmission of the physical downlink channel and the one of the tracking reference signal or synchronization signal.

In some embodiments, performing the data communication comprising: performing, during the first duration and on another cell in the plurality of cells other than the at least one cell, a transmission of the one of the tracking reference signal or synchronization signal for the at least one cell.

FIG. 15 is a simplified block diagram of a device 1500 that is suitable for implementing some embodiments of the present disclosure. The device 1500 can be considered as a further example embodiment of the terminal device 110 as shown in FIG. 1, or network devices 120 as shown in FIG. 1. Accordingly, the device 1500 can be implemented at or as at least a part of the above network devices or terminal devices.

As shown, the device 1500 includes a processor 1510, a memory 1520 coupled to the processor 1510, a suitable transmitter (TX) and receiver (RX) 1540 coupled to the processor 1510, and a communication interface coupled to the TX/RX 1540. The memory 1520 stores at least a part of a program 1530. The TX/RX 1540 is for bidirectional communications. The TX/RX 1540 has at least one antenna to facilitate communication, though in practice an Access Node mentioned in this application may have several ones. The communication interface may represent any interface that is necessary for communication with other network elements, such as X2 interface for bidirectional communications between gNBs or eNBs, SI interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1530 is assumed to include program instructions that, when executed by the associated processor 1510, enable the device 1500 to operate in accordance with the embodiments of the present disclosure, as discussed herein with reference to FIGS. 1-14. The embodiments herein may be implemented by computer software executable by the processor 1510 of the device 1500, or by hardware, or by a combination of software and hardware. The processor 1510 may be configured to implement various embodiments of the present disclosure. Furthermore, a combination of the processor 1510 and memory 1520 may form processing means 1550 adapted to implement various embodiments of the present disclosure.

The memory 1520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1520 is shown in the device 1500, there may be several physically distinct memory modules in the device 1500. The processor 1510 may be of any type suitable to the local technical network, and may include one or more of general purpose computers, special purpose computers, microprocessors, digital signal processors (DSPs) and processors based on multicore processor architecture, as non-limiting examples. The device 1500 may have multiple processors, such as an application specific integrated circuit chip that is slaved in time to a clock which synchronizes the main processor.

In some embodiments, a terminal device comprises circuitry configured to perform method 1300.

In some embodiments, a network device comprises circuitry configured to perform method 1400.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, technique terminal devices or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 3 to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-31. (canceled)

32. A method by a user equipment comprising:
receiving, from a network device, a configuration associated with a cell serving the user equipment,
wherein the configuration is for at least one of a first duration for an inactive mode of the cell and a second duration for an active mode of the cell, and
wherein the configuration comprises:
a periodicity for the inactive mode or the active mode;
a timing offset for the inactive mode or the active mode; and
a timer for the inactive mode or the active mode; and
performing, based on the configuration, a data communication with the network device via the cell.

33. The method according to claim 32,
wherein the cell is a first cell, and
wherein the configuration is for at least one of a third duration for an inactive mode of a second cell other than the first cell and a fourth duration for an active mode of the second cell.

34. The method according to claim 33,
wherein the first duration and the third duration at least partially do not overlap, or the second duration and the fourth duration at least partially do not overlap.

35. The method according to claim 32,
wherein the performing the data communication comprises:
determining a valid reception duration for the cell based on the second duration; and
performing a data reception during the valid reception duration.

36. A method by a network device comprising:
transmitting, to a user equipment, a configuration associated with a cell serving the user equipment,
wherein the configuration is for at least one of a first duration for an inactive mode of the cell and a second duration for an active mode of the cell, and
wherein the configuration comprises:
a periodicity for the inactive mode or the active mode;
a timing offset for the inactive mode or the active mode; and
a timer for the inactive mode or the active mode; and
performing, based on the configuration, a data communication with the user equipment via the cell.

37. The method according to claim 36,
wherein the cell is a first cell, and
wherein the configuration is for at least one of a third duration for an inactive mode of a second cell other than the first cell and a fourth duration for an active mode of the second cell.

38. The method according to claim 37,
wherein the first duration and the third duration at least partially do not overlap, or the second duration and the fourth duration at least partially do not overlap.

39. The method according to claim 36,
wherein performing the data communication comprising:
performing a data transmission during a valid duration for the cell,
wherein the valid duration for the cell is determined based on the second duration.

40. A user equipment comprising:
at least one memory; and
at least one hardware processor coupled to the at least one memory,
wherein the at least one hardware processor is configured to:
receive, from a network device, a configuration associated with a cell serving the user equipment,
wherein the configuration is for at least one of a first duration for an inactive mode of the cell and a second duration for an active mode of the cell, and
wherein the configuration comprises:
a periodicity for the inactive mode or the active mode;
a timing offset for the inactive mode or the active mode; and
a timer for the inactive mode or the active mode; and
perform, based on the configuration, a data communication with the network device via the cell.

41. A network device comprising:
at least one memory; and
at least one hardware processor coupled to the at least one memory,
wherein the at least one hardware processor is configured to:
transmit, to a user equipment, a configuration associated with a cell serving the user equipment,
wherein the configuration is for at least one of a first duration for an inactive mode of the cell and a second duration for an active mode of the cell, and
wherein the configuration comprises:
a periodicity for the inactive mode or the active mode;
a timing offset for the inactive mode or the active mode; and
a timer for the inactive mode or the active mode; and
perform, based on the configuration, a data communication with the user equipment via the cell.
